(19) United States
(12) Patent Application Publication
(10) Pub. No.: US 2010/0315058 A1
(43) Pub. Date: Dec. 16, 2010

(54) POWER SUPPLY APPARATUS WITH INRUSH CURRENT PREVENTION CIRCUIT

(76) Inventors: Chi-Shun LIAO, Taipei Hsien (TW); Ching-Chang Lin, Taipei Hsien (TW); Ben-Sheng Chen, Taipei Hsien (TW)

Correspondence Address: HDLS Patent & Trademark Services, P.O. BOX 220746, CHANTILLY, VA, 20153-0746, US

(21) Appl. No.: 12/485,165

(22) Filed: Jun. 16, 2009

(51) Int. Cl. G05F 5/00

(52) U.S. Cl. 323/299; 323/908

(57) ABSTRACT

A power supply apparatus with an inrush current prevention circuit is applied to a parallel power bus. The power supply apparatus includes a filter capacitor and a current control unit. The current control unit is electrically connected to the filter capacitor. The current control unit controls a charged current flowing through the filter capacitor to prevent an inrush current generated in the parallel power bus.

### BACKGROUND OF THE INVENTION

1. Field of the Invention

The present invention relates to a power supply apparatus, and more particularly to a power supply apparatus with an inrush current prevention circuit.

1. Description of Prior Art

Power supply system plays an important role to provide electricity to electronic apparatuses for an electronic system. Nowadays, many electronic systems are designed to provide reserve margin and further include multiple power supply apparatuses. More particularly, the power supply apparatuses are electrically connected to the electronic system through parallel power buses to provide sufficient electricity to the electronic system.

However, when any one of the power supply apparatuses is faulted, the faulted power supply apparatus is repaired to be hot swapped. Accordingly, the remaining power supply apparatuses of the electronic system can be continuously operated without shutting down the entire electronic system when the faulted power supply apparatus is replaced with a (new) non-faulted power supply apparatus. More particularly, the new non-faulted power supply apparatus provides a large uncharged filter capacitor between output terminals of the power supply apparatus. The uncharged filter capacitor absorbs an inrush current from generating from the parallel power bus when the new non-faulted power supply apparatus is instantly electrically connected to the parallel power bus. Hence, a large voltage dip (voltage sag) occurs in the parallel power bus (shown in FIG. 5) and causes an unstable power supply voltage.

An output current ripple of the power supply apparatus is large (shown in FIG. 3) if the filter capacitor connected between output terminals of the power supply apparatus is small. That is, a filter capacitor is provided to reduce the output current ripple of the power supply apparatus. Hence, an output current ripple of the power supply apparatus is reduced when a large filter capacitor (is labeled as 300A) is electrically connected between output terminals of the power supply apparatus (shown in FIG. 4). However, a large voltage dip (voltage sag) occurs in the parallel power bus and causes an unstable power supply voltage when the new non-faulted power supply apparatus is instantly electrically connected to the parallel power bus.

### SUMMARY OF THE INVENTION

In order to improve the disadvantages mentioned above, the prevent invention provides a power supply apparatus with an inrush current prevention circuit.

In order to achieve the objectives mentioned above, the power supply apparatus with the inrush current prevention circuit is applied to a parallel power bus. The power supply apparatus includes a filter capacitor and a current control unit. The current control unit is electrically connected to the filter capacitor. The current control unit controls a charged current flowing through the filter capacitor to prevent an inrush current from generating in the parallel power bus.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a block diagram of an active power supply apparatus with an inrush current prevention circuit according to the present invention;

FIG. 2 is an exemplary circuit diagram of the power supply apparatus with the inrush current prevention circuit;

FIG. 3 is a schematic view of output terminals of the power supply apparatus without a filter capacitor;

FIG. 4 is a schematic view of the output terminals of the power supply apparatus with the filter capacitor;

FIG. 5 is a timing sequence diagram of voltage and current at a prior art parallel power bus;

FIG. 6 is a timing sequence diagram of voltage and current at a parallel power bus according to present invention; and

FIG. 7 is a block diagram of the power supply apparatus with the inrush current prevention circuit.

### DETAILED DESCRIPTION OF THE INVENTION

In cooperation with attached drawings, the technical contents and detailed description of the present invention are described thereinafter according to a preferable embodiment, being not used to limit its executing scope. Any equivalent variation and modification made according to appended claims is all covered by the claims claimed by the present invention.

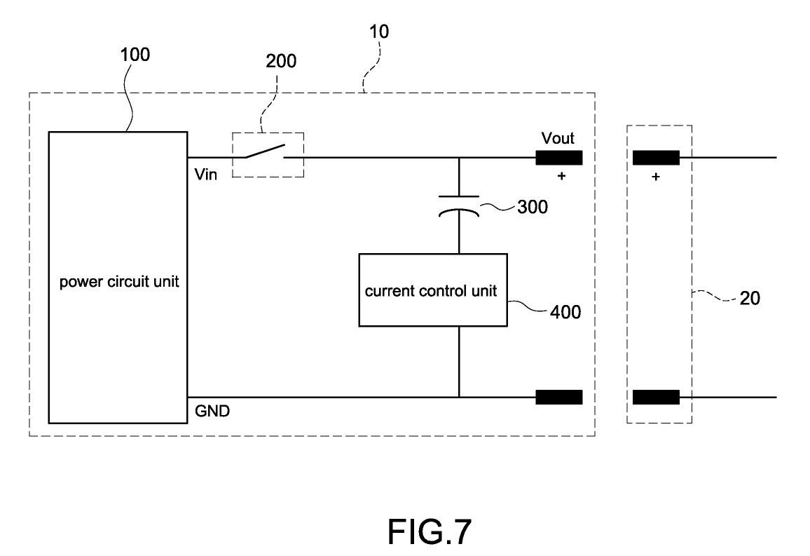

Reference is made to FIG. 7 which is a block diagram of a power supply apparatus with an inrush current prevention circuit. The power supply apparatus with an inrush current prevention circuit 10 is applied to a parallel power bus 20. The power supply apparatus 10 includes a power circuit unit 100, an OR'ing switch 200, a filter capacitor 300, and a current control unit 400. The OR'ing switch 200 is electrically connected to the power circuit unit 100 and the filter capacitor 300. The current control unit 400 is electrically connected to the filter capacitor 300.

The power circuit unit 100 can be a DC-to-DC power circuit or an AC-to-DC power circuit. The filter capacitor 300 can be an electrolytic capacitor. The current control unit 400 controls a charged current flowing through the filter capacitor 300 to prevent an inrush current from generating in the parallel power bus 20.

In safety consideration, a switch such as an OR'ing switch 200 can be connected in series to one output terminal of the power supply apparatus with hot swap function. The OR'ing switch 200 is turned on to permit the power circuit unit 10 to transmit electricity to the electronic system when the power circuit unit 100 is under a normal condition of providing electricity. More particularly, the current control unit 400 can be active or passive. The detailed description of the passive current control unit 400 is as following:

The current control unit 400 is implemented by a negative temperature coefficient (NTC) thermistor. A resistance value of the negative temperature coefficient (NTC) thermistor will decrease with increasing temperature. The resistance value of the current control unit 400 (namely the NTC thermistor) is extremely large when the power supply apparatus 10 is instantly electrically connected to the parallel power bus 20; thus, a charged current flowing through the filter capacitor 300 is extremely small. The resistance value of the current control unit 400 gradually reduces with gradually increasing temperature. The filter capacitor 300 can provide an optimal filter function and the inrush current is not generated when the resistance value of the current control unit 400 is extremely small.

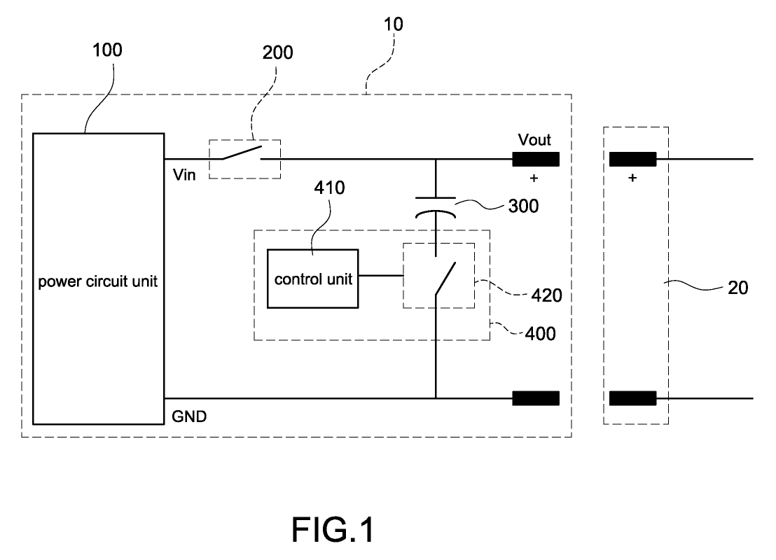

The detailed description of the active current control unit 400 is as following: Reference is made to FIG. 1 which is a block diagram of an active power supply apparatus with an inrush current prevention circuit according to the present invention. The power supply apparatus with the inrush current prevention circuit 10 is applied to the parallel power bus 20. The power supply apparatus 10 includes a control unit 410, a power switch unit 420, the filter capacitor 300, the power circuit unit 100, and the OR'ing switch 200. The power switch unit 420 is electrically connected to the control unit 410 and the filter capacitor 300. The OR'ing switch 200 is electrically connected to the power circuit unit 100 and the filter capacitor 300. The power circuit unit 100 can be a DC-to-DC power circuit or an AC-to-DC power circuit The filter capacitor 300 can be an electrolytic capacitor.

First, the power switch unit 420 is controlled to be at a switch-off state by the control unit 410 when the power supply apparatus 10 is instantly electrically connected the parallel power bus 20. Afterward, the power switch unit 420 is controlled to be operated at a linear resistance region by the control unit 410 when the power supply apparatus 10 is fully electrically connected to the parallel power bus 20. Thus, the charged current flowing through the filter capacitor 300 is controlled according to a resistance value of the power switch unit 420 operated at the linear resistance region. The power switch unit 420 is used to provide a switch function and further a function of controlling the charged current flowing through the filter capacitor 300. The power switch unit 420 is controlled to fully turn on by the control unit 410 when the filter capacitor 300 is charged to close to a voltage of the parallel power bus 20. Accordingly, the filter capacitor 300 is used to provide an optimal filter function.

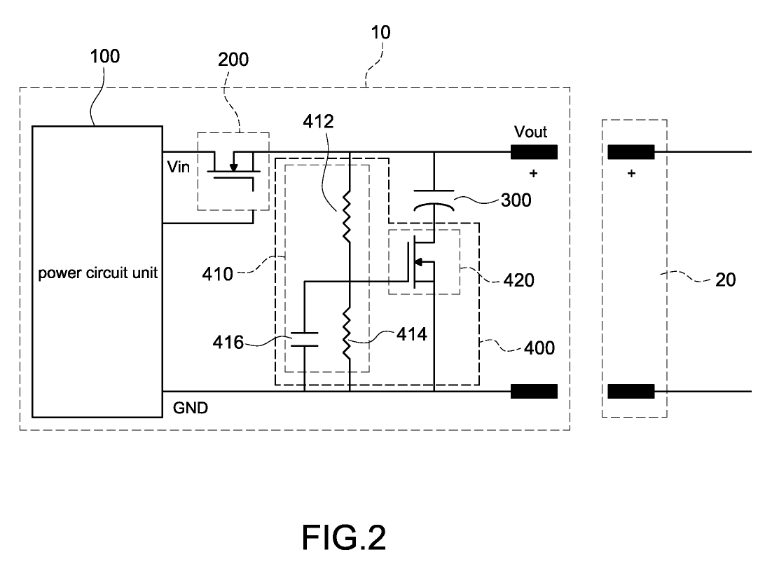

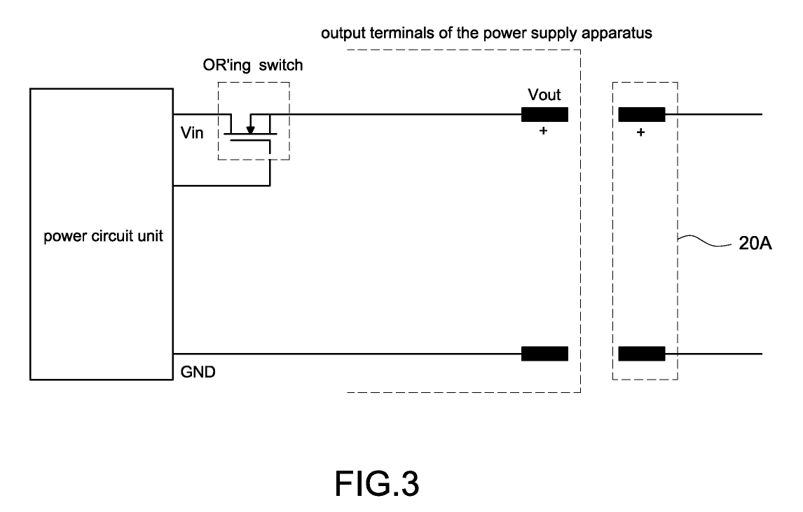

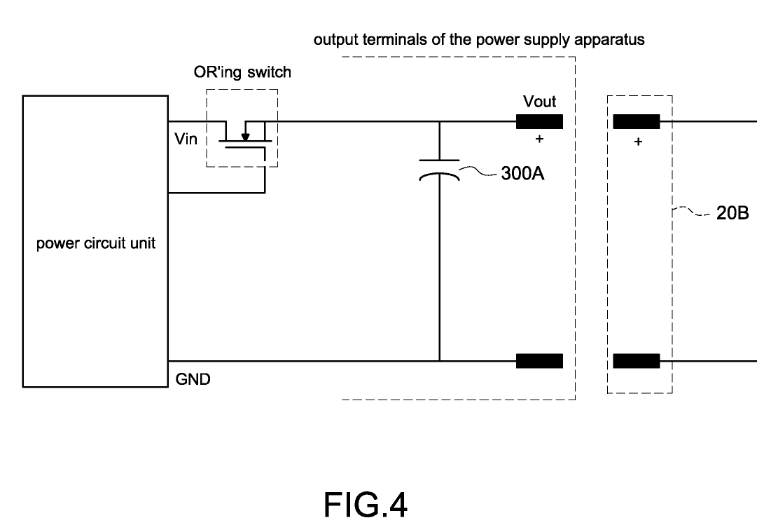

Reference is made to FIG. 2 which is an exemplary circuit diagram of the power supply apparatus with the inrush current prevention circuit. The power supply apparatus with an inrush current prevention circuit 10 is applied to a parallel power bus 20. The power supply apparatus 10 includes the control unit 410, the power switch unit 420, the filter capacitor 300, the power circuit unit 100, and the OR'ing switch 200. The power switch unit 420 is electrically connected to the control unit 410 and the filter capacitor 300. The OR'ing switch 200 is electrically connected to the power circuit unit 100 and the filter capacitor 300. The power circuit unit 100 can be a DC-to-DC power circuit or an AC-to-DC power circuit. The filter capacitor 300 can be an electrolytic capacitor. The power switch unit 420 is a metal-oxide-semiconductor field-effect-transistor (MOSFET).

The control unit 410 further includes a first resistor 412, a second resistor 414, and a first capacitor 416. One terminal of the first resistor 412 is electrically connected to the filter capacitor 300 and the other terminal of the first resistor 412 is electrically connected to the power switch unit 420. One terminal of the second resistor 414 is electrically connected to the power switch unit 420 and the other terminal of the second resistor 414 is electrically connected to a ground potential. In addition, one terminal of the first capacitor 416 is electrically connected to the power switch unit 420 and the other terminal of the first capacitor 416 is electrically connected to the ground potential.

First, both the OR'ing switch 200 and the power switch unit 420 are at a switch-off state when the power supply apparatus 10 is initially electrically connected to the parallel power bus 20. Afterward, the parallel power bus 20 charges the first capacitor 416 through the first resistor 412 and the second resistor 414. The power switch unit 420 is operated at the linear resistance region when the first capacitor 416 is charged up to a voltage. In addition, the parallel power bus 20 charges the filter capacitor 300. The charged current flowing through the filter capacitor 300 is limited below a limited current when the power switch unit 420 is operated at the linear resistance region. Thus, the power switch unit 420 is used to provide a switch function and further a function of controlling the charged current flowing through the filter capacitor 300. Finally, the filter capacitor 300 will provide the optimal filter function when the charged voltage of the first capacitor 416 is applied to conduct the power switch unit 420 at a switch-on state.

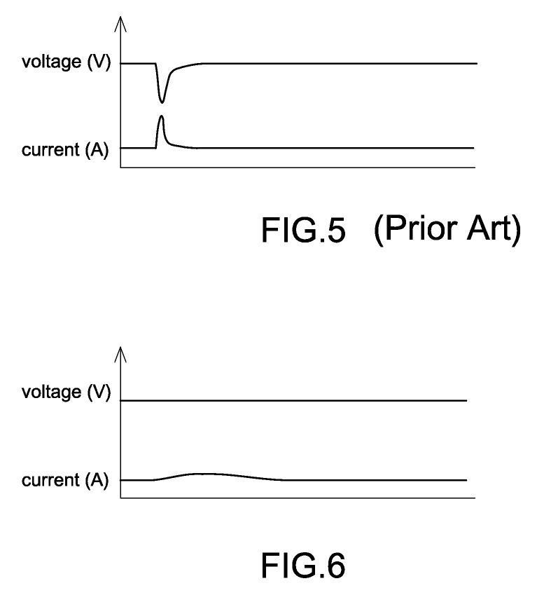

Reference is made to FIG. 5 which is a timing sequence diagram of voltage and current at a prior art parallel power bus. It is clear that a large inrush current (transient current) is generated in the parallel power bus 20 when the power supply apparatus 10 is suddenly connected to the parallel power bus 20. Hence, a voltage dip (voltage sag) occurs in the parallel power bus 20 and causes an unstable voltage in the parallel power bus 20. Reference is made to FIG. 6 which is a timing sequence diagram of voltage and current at a parallel power bus according to present invention. It is clear that the inrush current from generating in the parallel power bus 20 is extremely restrained when the power supply apparatus 10 is electrically connected to the parallel power bus 20. Hence, the voltage of the parallel power bus 20 is nearly constant.

The feature of the present invention is described as following:

The charged current flowing through the filter capacitor 300 is controlled by the current control unit 400 when a new (non-faulted) power supply apparatus is electrically connected to the parallel power bus 20. Hence, the filter capacitor 300 is gradually charged to prevent the inrush current from generating in the parallel power bus 20.

In conclusion, the power supply apparatus with the inrush current prevention circuit has the following advantages:

1. An electric spark is not generated between the parallel power bus and contacts of the power supply apparatus because the inrush current from generating in the parallel power bus is extremely restrained.

2. A larger filter capacitor can be provided between output terminals of the power supply apparatus to effectively restrain output voltage ripple and output current ripple because the inrush current from generating in the parallel power bus is extremely restrained.

3. A larger voltage dip (voltage sag) does not occur in the power bus and stable output electricity can be provided because the charged current flowing through the filter capacitor is restrained by the power switch unit.

4. In the prior art, the inrush current from generating in the parallel power bus causes a sufficient voltage dip (voltage sag), which results in possible malfunction of the electronic system. Accordingly, a backup power supply apparatus is boosted to provide unnecessary electricity to the electronic system. A false shut-down protection, and even, is automatically activated to save wrong data of the electronic system. However, in the present invention, the malfunction can be prevented by the power supply apparatus with the current prevention circuit.

5. In the prior art, the task of reducing the output current ripple of the power supply apparatus is processed before the electricity is transmitted to the electronic system. Hence, a large filter capacitor, which is used to avoid the generation of the inrush current, is not provided between output terminals of the power supply apparatus. However, in the present invention, the large filter capacitor is provided between output terminals of the power supply apparatus to extremely restrain the inrush current and further counteract the inductance effects produced from the OR'ing switch and other circuit components to reduce the output voltage ripple and the output current ripple.

Although the present invention has been described with reference to the preferred embodiment thereof, it will be understood that the invention is not limited to the details thereof Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A power supply apparatus with an inrush current prevention circuit applied to a parallel power bus, and the power supply apparatus comprising:
a filter capacitor; and
a current control unit electrically connected to the filter capacitor;
wherein the current control unit is adapted to control a charged current flowing through the filter capacitor to prevent an inrush current from generating in the parallel power bus.

2. The power supply apparatus in claim 1, wherein the current control unit further comprises:
a power switch unit electrically connected to the filter capacitor; and
a control unit electrically connected to the power switch unit;
wherein the control unit is adapted to control the power switch unit to control the charged current flowing through the filter capacitor to prevent an inrush current from generating in the parallel power bus.

3. The power supply apparatus in claim 2, wherein the control unit further comprises:
a first resistor, one terminal of the first resistor electrically connected to the filter capacitor and the other terminal of the first resistor electrically connected to the power switch unit;
a second resistor, one terminal of the second resistor electrically connected to the power switch unit and the other terminal of the second resistor electrically connected to a ground potential; and
a first capacitor, one terminal of the first capacitor electrically connected to the power switch unit and the other terminal of the first capacitor electrically connected to the ground potential.

4. The power supply apparatus in claim 2, wherein the power switch unit is a metal-oxide-semiconductor field-effect-transistor (MOSFET).

5. The power supply apparatus in claim 1, wherein the current control unit is a negative temperature coefficient (NTC) thermistor.

6. The power supply apparatus in claim 1, wherein the filter capacitor is an electrolytic capacitor.

7. The power supply apparatus in claim 1, wherein the power supply apparatus farther comprises an OR'ing switch electrically connected to the filter capacitor.

8. The power supply apparatus in claim 1, wherein the power supply apparatus farther comprises a power circuit unit electrically connected to the filter capacitor.
